(19) United States
(12) Patent Application Publication
(10) Pub. No.: US 2024/0347734 A1
(43) Pub. Date: Oct. 17, 2024

(54) POSITIVE ELECTRODE PLATE FOR LITHIUM-ION RECHARGEABLE BATTERY AND LITHIUM-ION RECHARGEABLE BATTERY

(71) Applicants: PRIMEARTH EV ENERGY CO., LTD., Kosai-shi (JP); TOYOTA JIDOSHA KABUSHIKI KAISHA, Toyota-shi (JP); PRIME PLANET ENERGY & SOLUTIONS, INC., Tokyo (JP)

(72) Inventor: Kazuya TAGA, Hamamatsu-shi (JP)

(73) Assignees: PRIMEARTH EV ENERGY CO., LTD., Kosai-shi (JP); TOYOTA JIDOSHA KABUSHIKI KAISHA, Toyota-shi (JP); PRIME PLANET ENERGY & SOLUTIONS, INC., Tokyo (JP)

(21) Appl. No.: 18/636,072

(22) Filed: Apr. 15, 2024

(30) Foreign Application Priority Data
Apr. 17, 2023 (JP) 2023-067408

(51) Int. Cl. H01M 4/62; H01M 4/02; H01M 4/131; H01M 10/0525

(52) U.S. Cl. CPC H01M 4/625; H01M 4/131; H01M 10/0525; H01M 2004/028

(57) ABSTRACT

A positive electrode plate for a lithium-ion rechargeable battery includes a positive electrode mixture layer including a positive electrode active material and a fibrous conductive material dispersed on the positive electrode active material, wherein the fibrous conductive material includes flat flaked aggregates of the fibrous conductive material that do not adhere to the positive electrode active material.

### CROSS-REFERENCE TO RELATED APPLICATIONS

This application is based upon and claims the benefit of priority from prior Japanese Patent Application No. 2023-067408, filed on Apr. 17, 2023, the entire contents of which are incorporated herein by reference.

### BACKGROUND

### 1. Field

The following description relates to a positive electrode plate for a lithium-ion rechargeable battery and a lithium-ion rechargeable battery, and more particularly, a positive electrode plate for a lithium-ion rechargeable battery and a lithium-ion rechargeable battery having a high overcharge tolerance.

### 2. Description of Related Art

Lithium-ion rechargeable batteries have large capacities and generate high voltages. Thus, lithium-ion rechargeable batteries are used as power supplies in, for example, vehicles such as battery electric vehicles and hybrid electric vehicles. Lithium-ion rechargeable batteries are also used in homes and factories as stationary batteries. There is a need for such lithium-ion rechargeable batteries to have even higher outputs.

In order to increase input and output of a rechargeable battery, a positive electrode active material having a large specific surface area may be used to reduce reaction resistance. Further, a fibrous conductive material may be used so that the active material having a high specific surface area further reduces the reaction resistance. The fibrous conductive material, such as carbon nanotubes (CNT) and carbon nanofibers (CNF), can form a conductive network between particles of the positive electrode active material even when used in a small amount because of the conductivity and shape of the fibrous conductive material. Thus, studies have been conducted to increase the ratio of the positive electrode active material in a positive electrode mixture layer.

International Publication No. 2012/036172 discloses an example of a carbon microfiber dispersion liquid in which carbon microfibers having an extremely high cohesive force and forming aggregates are uniformly dispersed and defibrated in an organic solvent in a stable dispersion state. In the field of rechargeable battery electrode materials, it is suggested to use such carbon microfibers as an additive for an electrode film. For example, carbon microfibers are mixed with a positive electrode active material, such as lithium cobalt oxide or lithium iron phosphate, as an additive for a positive electrode film in a rechargeable battery, having high output and high capacity and used in hybrid cars and electric vehicles. The added carbon microfibers are expected to increase conductivity, strength of the positive electrode film, density of the positive electrode film, and permeability of an electrolyte solution.

### SUMMARY

Such a highly conductive fibrous material disclosed in International Publication No. 2012/036172 can construct an effective conductive network even when used in a small amount and functions as a sufficient conductive material. In particular, carbon nanotubes having a high thermal conductivity (3000 to 5500 W/m·K) are also advantageous in terms of heat dissipation.

When the positive electrode active material having a high specific surface area is overcharged, an increased amount of generated heat accelerates decomposition of the electrolyte solution. Even though carbon nanotubes have a high thermal conductivity, when only a small amount is used due to the high conductivity as described above, heat dissipation may become insufficient. This would adversely affect the overcharge tolerance of the lithium-ion rechargeable battery.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a positive electrode plate for a lithium-ion rechargeable battery includes a positive electrode mixture layer including a positive electrode active material and a fibrous conductive material dispersed on the positive electrode active material, wherein the fibrous conductive material includes flat flaked aggregates of the fibrous conductive material that do not adhere to the positive electrode active material.

In the positive electrode plate, the flaked aggregates may each have a planar area of 2.84 μm² or greater.

In the positive electrode plate, the flaked aggregates may each have a thickness of 0.39 μm or less.

In the positive electrode plate, the flaked aggregates may have a porosity of 30% or less.

In the positive electrode plate, the flaked aggregates may be 0.04 wt % or greater of the entire fibrous conductive material.

In the positive electrode plate, the flaked aggregates may be 1.47 wt % or less of the entire fibrous conductive material.

In the positive electrode plate, the fibrous conductive material may have a length of 100 nm or greater.

In the positive electrode plate, the fibrous conductive material may have a length of 1000 nm or less.

In the positive electrode plate, the fibrous conductive material may be carbon nanotubes.

In the positive electrode plate, the positive electrode active material may be lithium nickel manganese cobalt oxide.

In another general aspect, a lithium-ion rechargeable battery includes the positive electrode plate.

The positive electrode plate for a lithium-ion rechargeable battery and the lithium-ion rechargeable battery according to the present disclosure sufficiently dissipate heat even when a small amount of the fibrous conductive material is used.

Other features and aspects will be apparent from the following detailed description, the drawings, and the claims.

### BRIEF DESCRIPTION OF THE DRAWINGS

FIG. 1 is a perspective view schematically showing the structure of a lithium-ion rechargeable battery in accordance with the present embodiment.

FIG. 2 is a diagram schematically showing the structure of a roll of an electrode body in accordance with the present embodiment.

FIG. 3 is a diagram schematically showing a surface of a positive electrode plate in accordance with the present embodiment.

FIG. 4 is a diagram schematically showing a surface of a positive electrode plate according to the related art.

FIG. 5 is a micrograph of the surface of the positive electrode plate in accordance with the present embodiment.

FIG. 6 is a micrograph of the surface of the positive electrode plate according to the related art.

FIG. 7 is a graph comparing a (maximum) heat generating speed (° C./sec) between a case in which flaked aggregates of the present embodiment are present and a case in which the flaked aggregates are absent.

FIG. 8 is a table comparing a change rate (%) of the heat generating speed (° C./sec) corresponding to differences in a planar area (μm²) of the flaked aggregates.

FIG. 9 is a graph comparing the change rate (%) of the heat generating speed (° C./sec) corresponding to differences in the planar area (μm²) of the flaked aggregates.

FIG. 10 is a table comparing the change rate (%) of the heat generating speed (° C./sec) corresponding to differences in a ratio of the flaked aggregates (to conductive material).

FIG. 11 is a graph comparing the change rate (%) of the heat generating speed (° C./sec) corresponding to differences in the ratio of the flaked aggregates (to conductive material).

FIG. 12 is a table comparing the change rate (%) of the heat generating speed (° C./sec) corresponding to differences in a thickness (μm) of the flaked aggregates.

FIG. 13 is a graph comparing the change rate (%) of the heat generating speed (° C./sec) corresponding to differences in the thickness (μm) of the flaked aggregates.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

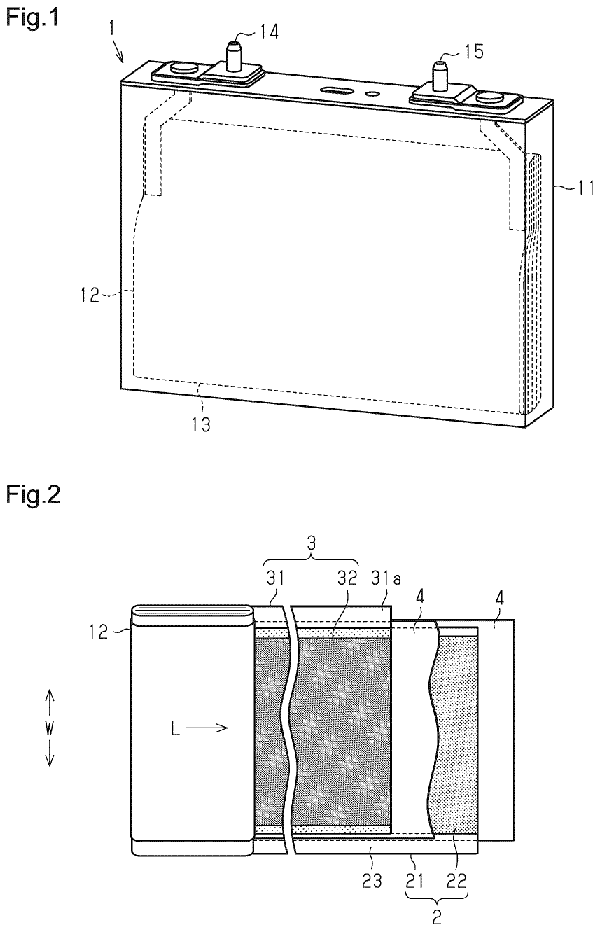

A positive electrode plate for a lithium-ion rechargeable battery and a lithium-ion rechargeable battery according to the present disclosure will now be described using an embodiment of a positive electrode plate 3 for a lithium-ion rechargeable battery 1 with reference to FIGS. 1 to 13.

### Principle of Present Embodiment

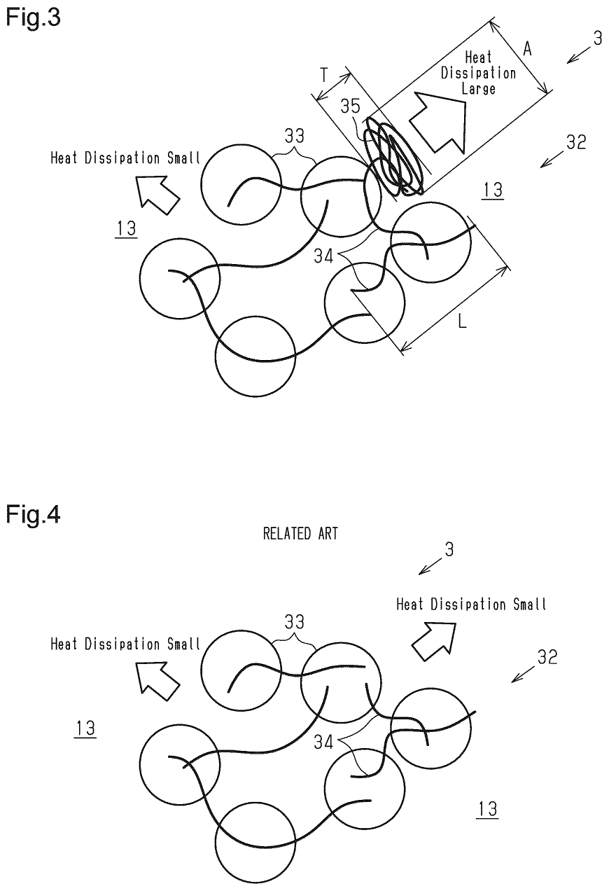

The principle of the present disclosure of the positive electrode plate 3 in accordance with present embodiment will be described. As described under “Description of Related Art” section, a fibrous conductive material 34, such as carbon nanotubes and carbon nanofibers, is used in the positive electrode plate 3 of the lithium-ion rechargeable battery 1 as shown in FIG. 3. In recent years, battery performance qualities have been improved by increasing the specific surface area of a positive electrode active material 33 so as to increase the contact area between the positive electrode active material 33 and a non-aqueous electrolyte solution 13. In this case, it is desired that a conductive network is formed to electrically connect surfaces of the particles of the positive electrode active material 33. Although the fibrous conductive material 34 is not limited to carbon nanotubes, carbon nanotubes have been used for various applications as a material having a combination of electrical, thermal, and mechanical effects. Thus, carbon nanotubes serve as the fibrous conductive material 34 in the present embodiment. It is typically desirable that the added carbon nanotubes be evenly dispersed to maximize the effect. Since an exceptionally strong cohesive force (van der Waals force) acts between defibrated carbon nanotubes, the carbon nanotubes are often distributed in a state defibrated and dispersed in a dispersion medium, such as water, organic solvent, and resin solution, to avoid aggregation.

A known positive electrode plate 3 is manufactured by kneading the positive electrode active material 33, the fibrous conductive material 34 dispersed in a medium, an organic solvent, and a binding material (binder), applying the kneaded positive electrode mixture paste to a positive electrode current collector 31, and then drying the paste. This manufacturing process obtains the positive electrode mixture paste in which carbon nanotubes are evenly dispersed.

In this case, as described above, even a small amount of the carbon nanotubes forms an effective conductive network because of its exceptionally high conductivity and fibrous shape. Thus, a smaller amount of the carbon nanotubes forms a sufficient conductive network than that of a conventional conductive material.

Further, the reduction in the amount of the conductive material allows for a relative increase in the amount of the positive electrode active material 33 in a positive electrode mixture layer 32. This is also advantageous in increasing the capacity of the positive electrode plate 3.

The lithium-ion rechargeable battery 1 used as a power supply in a battery electric vehicle or a hybrid electric vehicle may be overcharged due to quick charging or application of high regenerative current. In an overcharged state, temperature rises at the surfaces of the particles of the positive electrode active material 33 in the positive electrode. This may decompose the non-aqueous electrolyte solution 13 and deteriorate the battery. Accordingly, the positive electrode plate 3 of the present embodiment limits such increases in the temperature during overcharging.

FIG. 4 is a diagram schematically showing the surface of the positive electrode plate 3 in the related art. In the typical positive electrode plate 3, the fibrous conductive material 34 is dispersed and adhered to the surfaces of the particles of the positive electrode active material 33. The conductive paths between adjacent fibers of the fibrous conductive material 34 form a conductive network inside the positive electrode plate 3.

During overcharging, the temperature is increased at the surfaces of the particles of the positive electrode active material 33 that contact the non-aqueous electrolyte solution 13. In this case, the fibrous conductive material 34 conducts the generated heat from the surfaces of the particles of the positive electrode active material 33 in accordance with the thermal gradient. Further, the fibrous conductive material 34 dissipates the heat to the non-aqueous electrolyte solution 13. However, the fibrous conductive material 34 cannot dissipate the heat from portions where the fibrous conductive material 34 is in contact with the surfaces of the particles of the positive electrode active material 33 to the non-aqueous electrolyte solution 13. This limits the surface area that can dissipate the heat to the non-aqueous electrolyte solution 13 such that the heat dissipation performance is relatively low.

FIG. 3 is a diagram schematically showing the surface of the positive electrode plate 3 in accordance with the present embodiment. The positive electrode plate 3 of the present embodiment has the same basic structure as the typical positive electrode plate 3 shown in FIG. 4 except in that the positive electrode plate 3 of the present embodiment includes flaked aggregates 35 of the fibrous conductive material 34.

The flaked aggregates 35 are aggregates having the form of flake-like (disc-shaped) thin plates that are formed by aggregating part of the fibrous conductive material 34 before the fibrous conductive material 34 is manufactured into the positive electrode mixture paste.

Conventionally, the conductive material was maintained in a dispersed state to avoid the formation of aggregates since significance was placed on the conductive network. However, the inventors of the present embodiment have found that decomposition of the non-aqueous electrolyte solution 13 caused by the increased temperature at the surfaces of the particles of the positive electrode active material 33 during overcharging can be reduced. The present disclosure is based on a number of experiments on the fibrous conductive material 34 and findings obtained from extensive study of the results.

### Basic Structure of Present Embodiment

### Shape of Flaked Aggregate 35

In the lithium-ion rechargeable battery 1 of the present embodiment, the positive electrode mixture layer 32 of the positive electrode plate 3 includes the positive electrode active material 33 and the fibrous conductive material 34 dispersed on the positive electrode active material 33 (for example, surfaces of particles of the positive electrode active material 33). The fibrous conductive material 34 forms the flat flaked aggregates 35, most of which do not contact the positive electrode active material 33. In other words, the positive electrode mixture layer 32 of the positive electrode plate 3 of the lithium-ion rechargeable battery 1 includes the positive electrode active material 33 and the fibrous conductive material 34 and 35. The fibrous conductive material 34 and 35 includes the fibrous conductive material 34 dispersed on the surfaces of the particles of the positive electrode active material 33, and the flat flaked aggregates 35 that do not adhere to the positive electrode active material 33 or most of which do not contact the positive electrode active material 33. The term “flake” is a figurative expression and refers to a shape having the form of a substantially thin plate. Unlike the fibrous material, the aggregates 35 are flake-shaped to avoid adhesion to the surfaces of the particles of the positive electrode active material 33 and remain separated from the surfaces of the positive electrode active material 33. This maximizes the effect of the contact area between the flaked aggregates 35 and the non-aqueous electrolyte solution 13.

Planar Area A (μm²/g) of Flaked Aggregate 35

Specifically, it is desirable that the flaked aggregates 35 have an average planar area A (μm²) that is 2.8 μm² or greater. In the present embodiment, the planar area A (μm²) is an area of a bottom surface of each flaked aggregate 35 orthogonal to a thickness direction of the flaked aggregate 35. In the present embodiment, “average” means a median value (D₅₀: 50% average area) that corresponds to 50% accumulation in distribution of the areas obtained from a micrograph of the surface, unless otherwise specified. The same applies to other “average” numeric values, unless otherwise specified. When the flaked aggregates 35 have an average planar area A (μm²) that is 2.8 μm² or greater as described above, the contact area between the flaked aggregates 35 and the non-aqueous electrolyte solution 13 is relatively large so that heat is dissipated effectively.

### Thickness T (μm) of Flaked Aggregate 35

It is desirable that the flaked aggregates 35 have an average thickness T (μm) that is 0.4 μm or less. Such a thin form decreases the amount of heat stored inside the flaked aggregates 35 so that heat is dissipated effectively without being trapped.

### Porosity (%) of Flaked Aggregate 35

It is desirable that the flaked aggregates 35 have a porosity (%) of 30% or less. The porosity (%) refers to a ratio of the volume of voids to the total volume of the flaked aggregates 35. The porosity (%) is measured through, for example, optical determination or mercury porosimetry. If the porosity (%) of the flaked aggregates 35 exceeds 30%, the surface area will not be sufficient. Further, it is desirable that the porosity (%) of the flaked aggregates 35 be at least 10%. If the porosity (%) of the flaked aggregates 35 is less than 10%, distribution of the non-aqueous electrolyte solution 13 will become poor. This may increase the resistance against migration of ions.

### Ratio of Flaked Aggregate 35 to Entire Conductor

It is desirable that the flaked aggregates 35 be 0.04 wt % or greater of the entire fibrous conductive material 34. If the flaked aggregates 35 are less than 0.04 wt % of the entire fibrous conductive material 34, the heat dissipation performance may become insufficient.

It is desirable that the flaked aggregates 35 be less than or equal to 1.50 wt % of the entire fibrous conductive material 34. If the flaked aggregates 35 exceed 1.50 wt % of the entire fibrous conductive material 34, the flaked aggregates 35 are less likely to contribute to the conductive network due to its shape. This may also increase the resistance against migration of ions.

### Length (nm) of Fibrous Conductive Material 34

It is desirable that the fibrous conductive material 34 have a length of 100 nm or greater. If the length of the fibrous conductive material 34 is less than 100 nm, it will be difficult to form conductive paths between adjacent fibers of the fibrous conductive material 34. This may hinder formation of an efficient conductive network.

It is desirable that the fibrous conductive material 34 have a length of 1000 nm or less. If the length of the fibrous conductive material 34 is greater than 1000 nm, intermolecular force of hydrogen bonding between fibers of the fibrous conductive material 34 will form a large number of lump-like aggregates of the fibrous conductive material 34. Thus, the conductivity may become insufficient.

### Positive Electrode Active Material 33

Although the positive electrode active material 33 of the present disclosure is not particularly limited, the positive electrode active material 33 may be granulated lithium nickel manganese cobalt oxide having a large surface area. This is because the material easily releases oxygen and generates decomposition heat.

### Structure of Present Embodiment

### Structure of Lithium-Ion Rechargeable Battery

An example of the overall structure of the lithium-ion rechargeable battery 1 described in the present embodiment will now be described briefly.

FIG. 1 is a perspective view schematically showing the structure of the lithium-ion rechargeable battery 1 in accordance with the present embodiment. As shown in FIG. 1, the lithium-ion rechargeable battery 1 is structured as a battery cell. The lithium-ion rechargeable battery 1 includes a box-shaped battery case 11 having an opening in the upper side. The battery case 11 accommodates an electrode body 12. The battery case 11 is filled with the non-aqueous electrolyte solution 13 injected through a liquid injection hole. The battery case 11 is formed from a metal, such as an aluminum alloy, and forms a sealed battery container. Further, the lithium-ion rechargeable battery 1 includes a positive electrode external terminal 14 and a negative electrode external terminal 15 used for charging and discharging. The shapes of the positive electrode external terminal 14 and the negative electrode external terminal 15 are not limited to those shown in FIG. 1.

### Electrode Body 12

FIG. 2 is a diagram schematically showing the structure of a roll of the electrode body 12. The electrode body 12 is formed by a flat roll of a negative electrode plate 2 and the positive electrode plate 3 with separators 4 held in between. In the negative electrode plate 2, a negative electrode mixture layer 22 is formed on a negative electrode current collector 21 that serves as a substrate. The negative electrode plate 2 includes a negative electrode connector 23 where the negative electrode mixture layer 22 is not formed such that the negative electrode current collector 21 is exposed at one end of the electrode body 12 in a widthwise direction W (rolling axis direction) that is orthogonal to a direction in which the electrode body 12 is rolled (rolling direction L).

### Stack Structure of Electrode Body 12

As shown in FIG. 2, the electrode body 12 of the lithium-ion rechargeable battery 1 includes the negative electrode plate 2, the positive electrode plate 3, and the separators 4.

The negative electrode plate 2 and the positive electrode plate 3 are stacked with the separators 4 held in between. The stack is rolled in its longitudinal direction about the rolling axis to form the flat roll of the rolled-type electrode body 12.

The negative electrode plate 2 includes the negative electrode mixture layer 22 on two opposite surfaces of the negative electrode current collector 21, which serves as the negative electrode substrate. An end portion of the negative electrode current collector 21 located at one side of the electrode body 12 in the widthwise direction W (rolling axial direction) defines the negative electrode connector 23 where metal is exposed.

The positive electrode plate 3 includes the positive electrode mixture layer 32 on two opposite surfaces of the positive electrode current collector 31, which serves as the positive electrode substrate. An end portion of the positive electrode current collector 31 located at the other side of the electrode body 12 in the widthwise direction W (rolling axial direction) defines the positive electrode connector 31a where metal is exposed.

### Non-Aqueous Electrolyte Solution 13

As shown in FIG. 1, the battery container formed by the battery case 11 is filled with the non-aqueous electrolyte solution 13. The non-aqueous electrolyte solution 13 of the lithium-ion rechargeable battery 1 is a composition in which a lithium salt is dissolved in an organic solvent. The lithium salt may include LiClO₄, LiPF₆, LiAsF₆, LiBF₄, LiSO₃CF₃ or the like. Examples of the organic solvent include a cyclic carbonate such as ethylene carbonate (EC), propylene carbonate (PC), butylene carbonate, or trifluoropropylene carbonate (F·PC); a chain carbonate such as diethyl carbonate (DEC), dimethyl carbonate (DMC), ethyl methyl carbonate (EMC), or dipropyl carbonate (DPC); an ether compound such as tetrahydrofuran (TFH), 2-methyltetrahydrofuran (2-MeTHF), or dimethoxyethane; a sulfur compound such as ethyl methyl sulfone or butane sultone; and a phosphorus compound such as triethyl phosphate or trioctyl phosphate. The non-aqueous electrolyte solution may include one selected from the above or a mixture of two or more selected from the above. The non-aqueous electrolyte solution 13 is not limited to such a composition.

### Components of Electrode Body 12

The components of the electrode body 12, namely, the negative electrode plate 2, the positive electrode plate 3, and the separator 4, will now be described.

In the present embodiment, “average diameter” means a median diameter (D50: 50% volume average particle diameter) that corresponds to 50% accumulation in a volume-based particle size distribution, unless specified otherwise. In a range where the average particle diameter is approximately 1 μm or greater, the average diameter can be obtained by a laser diffraction and light scattering method. In a range where the average particle diameter is approximately 1 μm or less, the average particle diameter can be obtained by a dynamic light scattering (DLS) method. The average particle diameter obtained by the DLS method may be measured in accordance with Japanese Industrial Standards (JIS) Z 8828:2013.

### Negative Electrode Plate 2

The negative electrode plate 2 has a structure in which the negative electrode mixture layer 22 is formed on both surfaces of the negative electrode current collector 21, which serves as the negative electrode substrate. The negative electrode current collector 21 is formed by a Cu foil in the embodiment. The negative electrode current collector 21 acts as the base of the negative electrode mixture layer 22 and functions as a current collecting member that collects electricity from the negative electrode mixture layer 22. In the present embodiment, a negative electrode active material includes a material that is capable of storing and releasing lithium ions, namely, powders of a carbon material such as graphite or the like.

The negative electrode plate 2 is prepared by, for example, kneading the negative electrode active material, a solvent, and a binding material (binder), applying the kneaded negative electrode mixture paste to the negative electrode current collector 21, and then drying the paste.

### Positive Electrode Plate 3

FIG. 3 is a diagram schematically showing the surface of the positive electrode plate 3 in accordance with the present embodiment.

The positive electrode plate 3 includes the positive electrode current collector 31 (FIG. 2) and the positive electrode mixture layer 32 applied to the positive electrode current collector 31.

### Positive Electrode Current Collector 31

As shown in FIG. 2, the positive electrode plate 3 has a structure in which the positive electrode mixture layer 32 is formed on both surfaces of the positive electrode current collector 31, which serves as the positive electrode substrate. The positive electrode current collector 31 is formed by an aluminum foil in the embodiment. The positive electrode current collector 31 acts as the base of the positive electrode mixture layer 32 and functions as a current collecting member that collects electricity from the positive electrode mixture layer 32.

An Al foil is described above as an example of the positive electrode substrate that forms the positive electrode current collector 31. The positive electrode substrate is formed from, for example, a conductive material including a metal having satisfactory electric conduction. The conductive material may include, for example, a material including aluminum or an aluminum alloy. The structure of the positive electrode current collector 31 is not limited to the above description.

### Positive Electrode Mixture Layer 32

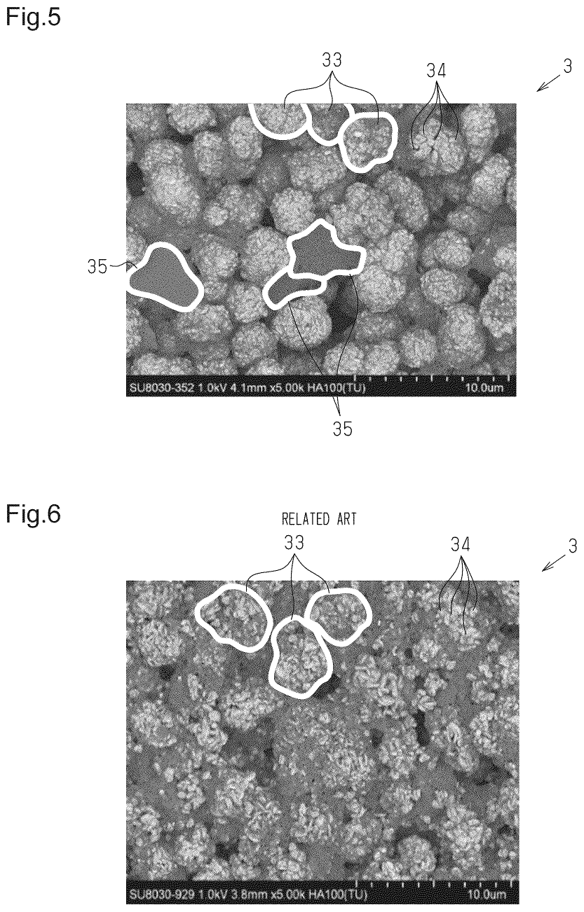

As shown in FIG. 5, the positive electrode mixture layer 32 is formed by applying the positive electrode mixture paste to the positive electrode current collector 31 and drying the paste. In addition to the positive electrode active material 33, the fibrous conductive material 34, and the flaked aggregates 35, the positive electrode mixture layer 32 further includes a binding material (binder) and additives such as a dispersant and the like.

### Composition of Positive Electrode Active Material 33

The particles of the positive electrode active material 33 are not limited to those described in the embodiment and include a lithium transition metal oxide having a layered crystalline structure. The lithium transition metal oxide includes one or more predetermined transition metal elements in addition to Li. Preferably, the transition metal element included in the lithium transition metal oxide is at least one of Ni, Co, and Mn. A preferred example of the lithium transition metal oxide includes every one of Ni, Co, and Mn.

The positive electrode active material 33 may include one or more types of elements in addition to the transition metal element (i.e., at least one of Ni, Co, and Mn). The additional element of the positive electrode active material 33 may include any element in group 1 (alkali metal such as sodium), group 2 (alkaline earth metal such as magnesium or calcium), group 4 (transition metal such as titanium or zirconium), group 6 (transition metal such as chromium or tungsten), group 8 (transition metal such as iron), group 13 (metalloid element such as boron or metal such as aluminum), or group 17 (halogen such as fluorine) of the periodic table.

The present embodiment uses lithium nickel manganese cobalt oxide, which is a granulated material having a large surface area that easily releases oxygen and generates decomposition heat.

### Fibrous Conductive Material 34

The fibrous conductive material 34 is a material that forms conductive paths in the positive electrode mixture layer 32. An appropriate amount of the fibrous conductive material 34 mixed into the positive electrode mixture layer 32 increases the conductivity of the positive electrode and improves the charging/discharging efficiency and the output characteristics of the battery. The conductor of the present embodiment may include, for example, the fibrous conductive material 34 formed from a carbon material such as carbon nanotubes (CNT), carbon nanofibers (CNF), or the like. Further, it is desirable that the fibrous conductive material 34 have the form of a string having an aspect ratio of the length to the diameter of thirty or greater. Preferably, the length of the fibrous conductive material 34 is in a range of 100 nm to 1000 nm. A length less than 100 nm will hinder the formation of a sufficient conductive network. A length greater than 1000 nm will hinder dispersion of the fibrous conductive material 34.

The present embodiment uses carbon nanotubes having a length in a range of 100 nm to 1000 nm.

### Flaked Aggregate 35

The flaked aggregates 35 of the present embodiment have the form of substantially disc-shaped thin plates. The flaked aggregates 35 have an average planar area A (μm²) that is 2.8 μm² or greater. The flaked aggregates 35 have an average thickness T (μm) that is 0.4 μm or less. The flaked aggregates 35 have a porosity (%) in a range of 10 to 30%. The ratio (wt %) of the flaked aggregates 35 to the entire conductor is in a range of 0.04 wt % to 1.50 wt % of the entire fibrous conductive material 34.

### Binding Material (Binder)

Examples of the binder include polyvinylidene fluoride (PVdF), polytetrafluoroethylene (PTFE), polyacrylic acid, polyacrylate, or the like.

### Method for Manufacturing Positive Electrode Plate

As shown in FIG. 2, the positive electrode plate 3 includes the positive electrode current collector 31 and the positive electrode mixture layer 32 applied to the positive electrode current collector 31. The positive electrode mixture layer 32 is formed by applying a positive electrode mixture paste to the positive electrode current collector 31 and drying the paste. The positive electrode mixture paste is manufactured by mixing and kneading the positive electrode active material 33, the fibrous conductive material 34, the flaked aggregates 35, the binding material (binder), and the additives such as a dispersant and the like.

Typically, carbon nanotubes are evenly dispersed in a dispersion medium, such as an organic solvent, and directly mixed with the positive electrode active material 33, the binder, and the additives such as a dispersant and the like, and then kneaded after a nonvolatile content ratio NV (%) and a viscosity (Pa·s) are adjusted with a solvent. This manufacturing process obtains the positive electrode mixture paste in which carbon nanotubes are evenly dispersed.

In the present embodiment, the carbon nanotubes are evenly dispersed in a dispersion medium, such as an organic solvent, and aggregated in advance. Since an exceptionally strong cohesive force (van der Waals force) acts between defibrated carbon nanotubes and between aggregates of several nanometers to several tens of nanometers, the carbon nanotubes are distributed in a state defibrated in a dispersion medium such as an organic solvent. In the present embodiment, a shear force is applied to the carbon nanotubes in the dispersed state to purposely cause aggregation. This process is performed in advance with the conductive material 34 dispersed in the medium. However, this process may be performed with the conductive material 34 in the paste.

A colloid mill may be used to apply such a shear force. A colloid mill is a generic term for grinding machines used to obtain microscopic particles. A colloid mill is an apparatus used to reduce the size of particles to a level that cannot be obtained with an ordinary grinding means. Solid particles together with a liquid are fed into a gap between two surfaces rotating in extremely close proximity, and a shear force is applied to the liquid so that the solid particles are pulverized and dispersed in the liquid. When the rotating surfaces are toothed, a colloid having a particle size of 1 μm or less can be obtained. Other than such a wet-type colloid mill, the colloid mill may be of various types, for example, a dry type. These various colloid mills are used, for example, in industries such as paper milling, rubbers, cosmetics, food fillers, pigments, paints, and enamel. The colloid mill of the present embodiment includes, for example, a wet-type carbon nanotube grinding machine such as MK 2000 manufactured by IKA Japan Corporation.

Although a colloid mill is typically used to reduce the size of a relatively large solid particles, the present inventors have conducted studies and found that the colloid mill can be used with defibrated carbon nanotubes in a dispersion medium to purposely form aggregates.

### Formation of Flaked Aggregate 35

In the present embodiment, physical properties of the carbon nanotube dispersion liquid, such as a nonvolatile content ratio NV (%) and a viscosity (Pa·s), are used as conditions for controlling the aggregation by the colloid mill. Further, the colloid mill was set to operate under conditions related to a gap dimension (μm) between two rotary bodies, agitation speed (rpm), temperature (° C.), agitation time (sec), and the like. These conditions affected the formation of the aggregates.

Accordingly, the physical properties of the dispersion liquid including the nonvolatile content ratio NV (%) and the viscosity (Pa·s) serve as parameters. The conditions related to gap dimension (μm), agitation speed (rpm), temperature (° C.), and agitation time (sec) also serve as parameters. These parameters are controlled to obtain aggregates having desired shape, planar area A (μm²), thickness T (μm), porosity (%), and mixing amount (wt %). In particular, the nonvolatile content ratio NV (%) and the viscosity (Pa·s) are easy to adjust, and increases in the nonvolatile content ratio NV (%) and the viscosity (Pa·s) facilitate the aggregation. Thus, the aggregates will have desired shape, planar area A (μm²), thickness T (μm) and the like by adjusting these parameters. However, excessive agitation may form aggregates having irregular shapes.

### Nonvolatile Content Ratio NV (%)

When the nonvolatile content ratio NV (%) was increased, the planar area A (μm²) and the thickness T (μm) of the flaked aggregates 35A were likely to increase. It can be understood that this is because the carbon nanotubes came into contact with one another more frequently. In contrast, when the nonvolatile content ratio NV (%) was decreased, the planar area A (μm²) and thickness T (μm) of the flaked aggregates 35 were likely to decrease. Such tendency was observed in a certain range and may differ in other ranges. Thus, actual experiments should be conducted over a wider range to confirm the tendency.

### Viscosity (Pa·s)

When the viscosity (Pa·s) was decreased, the thickness T (μm) was likely to decrease. It can be understood that the high fluidity of the paste reduced contacts between the carbon nanotubes in the thickness direction. In this case, the planar area A (μm²) had no prominent tendency. In contrast, when the viscosity (Pa·s) was increased, the thickness T (μm) was likely to increase. Such tendency was observed in a certain range and may differ in other ranges. Thus, actual experiments should be conducted over a wider range to confirm the tendency.

### Gap (μm)

When the gap (μm) between the two rotary bodies was increased, the planar area A (μm²) and thickness T (μm) of the flaked aggregates 35 were likely to increase. It can be understood that this is because the carbon nanotubes came into contact with one another more frequently in each direction as the gap (μm) increases. In contrast, when the gap (μm) between the two rotary bodies was decreased, the planar area A (μm²) and the thickness T (μm) of the flaked aggregates 35 were likely to decrease. It can be understood that the shear force increased as the gap (μm) became narrower. Such tendency was observed in a certain range and may differ in other ranges. Thus, actual experiments should be conducted over a wider range to confirm the tendency.

Agitation Speed (rpm)

When the agitation speed (number of rotation) (rpm) was decreased, the planar area A (μm²) of the flaked aggregates 35 was likely to increase. In this case, the thickness T (μm) had no notable tendency. In contrast, when the agitation speed (number of rotation) (rpm) was increased, the planar area A (μm²) of the flaked aggregates 35 was likely to decrease. It can be understood that this is because the aggregates became loosened by the fast rotations. Such tendency was observed in a certain range and may differ in other ranges. Thus, actual experiments should be conducted over a wider range to confirm the tendency.

### Processing Temperature (° C)

When the processing temperature (° C) was increased, the planar area A (μm²) of the flaked aggregates 35 was likely to increase. It can be understood that this is because a high temperature (° C.) increased the kinetic energy such that the carbon nanotubes came into contact with one another more frequently. In contrast, when the processing temperature (° C.) was decreased, the planar area A (μm²) of the flaked aggregates 35 was likely to decrease. In this case, the thickness T (μm) had no notable tendency. Such tendency was observed in a certain range and may differ in other ranges. Thus, actual experiments should be conducted over a wider range to confirm the tendency.

Agitation Time (sec)

When the agitation time (sec) of the agitation process was increased, the planar area A (μm²) of the flaked aggregates 35 was likely to decrease. It can be understood that this is because the aggregates became loosened as the agitation time became longer. In contrast, when the processing time (sec) was decreased, the planar area A (μm²) of the flaked aggregates 35 was likely to increase. In this case, the thickness T (μm) had no notable tendency. Such tendency was observed in a certain range and may differ in other ranges. Thus, actual experiments should be conducted over a wider range to confirm the tendency.

### Controlling Formation of Flaked Aggregate 35

As described above, the formation of aggregation was affected by the nonvolatile content ratio NV (%), viscosity (Pas), gap (μm), agitation speed (rpm), temperature (° C.), agitation time (sec), and the like. When these conditions were changed, certain tendencies were observed in the formation of the flaked aggregates 35. This confirms that the planar area A (μm²) and the thickness T (μm) of the flaked aggregates 35 can be controlled. In particular, the nonvolatile content ratio NV (%) and the viscosity (Pa·s) are easily adjusted with the solvent. However, such adjustments of the conditions do not have a linear corresponding relationship with the results, and the relationship is limited to certain ranges. Therefore, measurements were performed through actual experiments in advance, and the observed tendencies were reflected to obtain desired planar area A (μm²) and thickness T (μm) of the flaked aggregates 35.

### Structure of Flaked Aggregate 35

FIG. 5 is a micrograph of the surface of the positive electrode plate 3 in accordance with the present embodiment. FIG. 6 is a micrograph of the surface of the positive electrode plate 3 in the related art. As shown in FIG. 6, the granular particles of the positive electrode active material 33, such as ones surrounded by the while lines, are observed on the surface of the typical positive electrode plate 3. Further, a large number of thread-like fibers of the fibrous conductive material 34 adhere to the surfaces of the granular particles of the positive electrode active material 33. As shown in FIG. 5, in the positive electrode plate 3 of the present embodiment, a large number of fibers of the fibrous conductive material 34 adhere to the surfaces of the granular particles of the positive electrode active material 33. In addition, black large flaked aggregates 35, surrounded by the white lines, are observed. Since the flaked aggregates 35 do not adhere to the granular positive electrode active material 33, the flaked aggregates 35 can be in contact with the non-aqueous electrolyte solution 13.

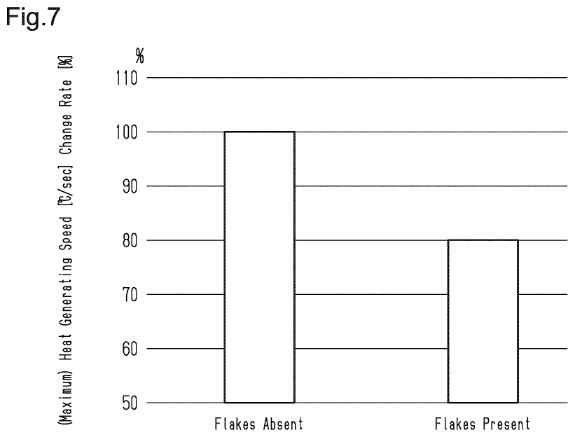

FIG. 7 is a graph comparing a change rate (%) of a (maximum) heat generating (temperature increasing) speed (° C./sec) between a case in which the flaked aggregates 35 of the present embodiment are present and a case in which the flaked aggregates 35 are absent. Specifically, the change rate (%) of the (maximum) heat generating speed (° C./sec) was compared between the typical positive electrode plate 3 in an overcharged state under a certain condition and the positive electrode plate 3 of the present embodiment in the same overcharged state. In this case, the (maximum) heat generating speed (° C./sec) of the typical positive electrode plate 3 was defined as a reference of 100.

As shown in the graph, when the typical positive electrode plate 3 and the positive electrode plate 3 of the present embodiment were heated in the same state under the same condition, the surface temperature (° C.) of the positive electrode active material 33 increased to the same temperature (° C.).

This proves that the difference in the change rate (%) of the (maximum) heat generating speed (° C./sec) resulted from the presence of the flaked aggregates 35.

### EXPERIMENTAL EXAMPLES OF PRESENT EMBODIMENT

Subsequently, the change rate (%) of the (maximum) heat generating speed (° C./sec) was measured under different conditions of the planar area A (μm²) and the thickness T (μm) of the flaked aggregates 35 and a ratio R (wt %) of the flaked aggregates 35 to the entire conductive material.

### Experiment 1: Change Rate (%) of (Maximum) Heat Generating Speed (° C./sec) Corresponding to Difference in Planar Area A (μm²)

### Conditions for Experiment 1

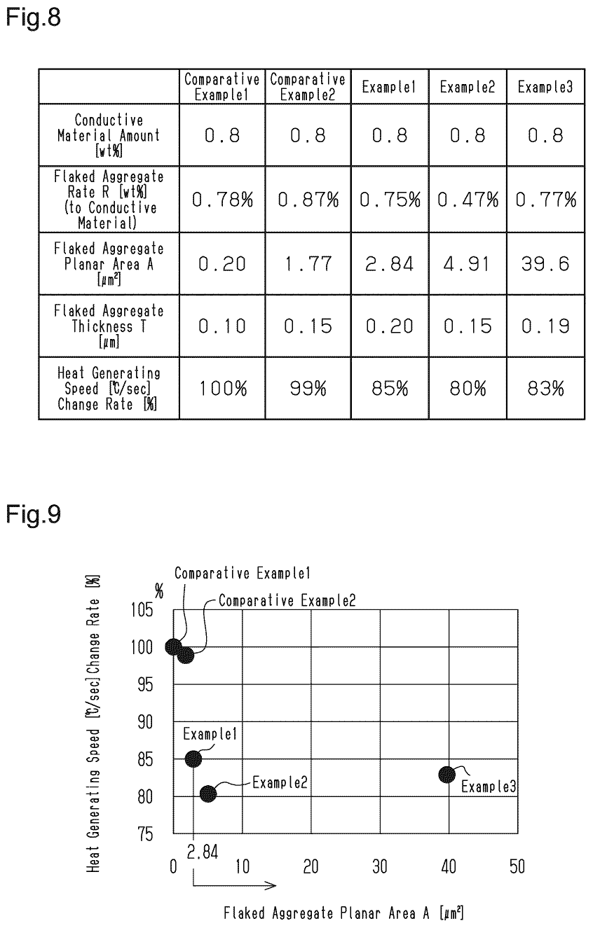

FIG. 8 is a table comparing the change rate (%) of the heat generating speed (° C./sec) corresponding to differences in the planar area A (μm²) of the flaked aggregates 35. FIG. 9 is a graph comparing the change rate (%) of the heat generating speed (° C./sec) of the positive electrode plate 3 corresponding to differences in the planar area A (μm²) of the flaked aggregates 35.

Examples 1 to 3 and Comparative Examples 1 to 2 are compared below. In each example, the total amount of the fibrous conductive material 34 (including flaked aggregates 35) was 0.8 wt % of the positive electrode mixture layer 32.

In Comparative Example 1, the ratio R (wt %) of the flaked aggregates 35 to the entire conductive material was set to 0.78 wt %. The planar area A (μm²) of the flaked aggregates 35 was set to 0.20 μm². The thickness T (μm) of the flaked aggregates 35 was set to 0.10 μm. In this case, the change rate (%) of the heat generating speed (° C./sec) of the positive electrode plate 3 was defined as a reference of 100%.

In Comparative Example 2, the ratio R (wt %) of the flaked aggregates 35 to the entire conductive material was set to 0.87 wt %. The planar area A (μm²) of the flaked aggregates 35 was set to 1.77 μm². The thickness T (μm) of the flaked aggregates 35 was set to 0.15 μm. In this case, the change rate (%) of the heat generating speed (° C./sec) of the positive electrode plate 3 was 99%.

In Example 1, the ratio R (wt %) of the flaked aggregates 35 to the entire conductive material was set to 0.75 wt %. The planar area A (μm²) of the flaked aggregates 35 was set to 2.84 μm². The thickness T (μm) of the flaked aggregates 35 was set to 0.20 μm. In this case, the change rate (%) of the heat generating speed (° C./sec) of the positive electrode plate 3 was 85%.

In Example 2, the ratio R (wt %) of the flaked aggregates 35 to the entire conductive material was set to 0.47 wt %. The planar area A (μm²) of the flaked aggregates 35 was set to 4.91 μm². The thickness T (μm) of the flaked aggregates 35 was set to 0.15 μm. In this case, the change rate (%) of the heat generating speed (° C./sec) of the positive electrode plate 3 was 80%.

In Example 3, the ratio R (wt %) of the flaked aggregates 35 to the entire conductive material was set to 0.77 wt %. The planar area A (μm²) of the flaked aggregates 35 was set to 39.6 μm². The thickness T (μm) of the flaked aggregates 35 was set to 0.19 μm. In this case, the change rate (%) of the heat generating speed (° C./sec) of the positive electrode plate 3 was 83%.

### Summary of Experiment 1

FIG. 9 is a graph comparing the change rate (%) of the heat generating speed (° C./sec) of the positive electrode plate 3 corresponding to differences in the planar area A (μm²) of the flaked aggregates 35. As shown in FIG. 9, the change rate (%) of the heat generating speed (° C./sec) was 100% in Comparative Example 1, and 99% in Comparative Example 2. In contrast, the change rate (%) of the heat generating speed (° C./sec) was 85% in Example 1, 80% in Example 2, and 83% in Example 3. This indicates that Examples 1 to 3 significantly reduced heat generation.

In this case, the total amount of the fibrous conductive material 34 (including flaked aggregate 35) was 0.8 wt % of the positive electrode mixture layer 32 in each example. Further, the ratio R (wt %) of the flaked aggregates 35 to the entire conductive material including the flaked aggregates 35 was in a range of 0.75 to 0.87 wt %, except for 0.47 wt % of Example 2. The thickness T (μm) of the flaked aggregates 35 was in a range of 0.10 to 0.20. In particular, Example 2 had a low ratio R (wt %) of the flaked aggregates 35, which was 0.47 wt %. This indicates that even when the amount of the flaked aggregates 35 was disadvantageously small, such as in Example 2 in which the ratio R (wt %) of the flaked aggregates 35 to the entire conductive material including the flaked aggregates 35 was a relatively small value of 0.47 wt %, heat generation was significantly reduced.

The planar area A (μm²) of the flaked aggregates 35 was 0.20 μm² in Comparative Example 1, and 1.77 μm² in Comparative Example 2, which were relatively small. The planar area A (μm²) of the flaked aggregates 35 was 2.84 μm² in Example 1, and 4.91 μm² in Example 2, which were relatively large. Further, Example 3 had an extremely large value of 39.6 μm².

These experimental results indicate that when the planar area A of the flaked aggregates 35 was greater than or equal to 2.84 μm², the change rate (%) of the heat generating speed (° C./sec) was 85% in Example 1, 80% in Example 2, and 83% in Example 3. Thus, Examples 1 to 3 significantly reduced heat generation.

### Conclusion of Experiment 1

As shown in FIG. 9, Experiment 1 confirmed that in order to reduce heat generation effectively, it is desirable that the flaked aggregates 35 have the planar area A of 2.84 μm² or greater.

### Experiment 2: Change Rate (%) of (Maximum) Heat Generating Speed (° C./sec) Corresponding to Difference in Ratio R (wt %) of Flaked Aggregate 35 to Entire Conductive Material

### Conditions for Experiment 2

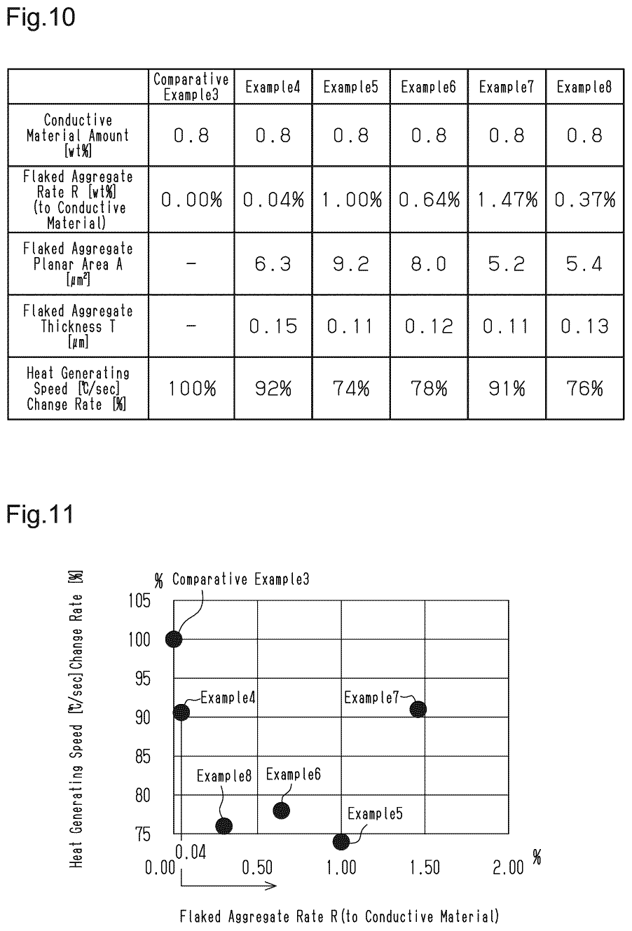

FIG. 10 is a table comparing the change rate (%) of the heat generating speed (° C./sec) corresponding to differences in the ratio R of the flaked aggregates 35 (to conductive material). FIG. 11 is a graph comparing the change rate (%) of the heat generating speed (° C./sec) corresponding to differences in the ratio R of the flaked aggregates 35 (to conductive material).

Examples 4 to 8 and Comparative Example 3 are compared below. In each example, the total amount of the fibrous conductive material 34 (including flaked aggregates 35) was 0.8 wt % of the positive electrode mixture layer 32.

In Comparative Example 3, the ratio R (wt %) of the flaked aggregates 35 to the entire conductive material was set to 0 wt %. That is, the flaked aggregates 35 were not included. In this case, the change rate (%) of the heat generating speed (° C./sec) of the positive electrode plate 3 was defined as a reference of 100%.

In Example 4, the ratio R (wt %) of the flaked aggregates 35 to the entire conductive material was set to 0.04 wt %. The planar area A (μm²) of the flaked aggregates 35 was set to 6.3 μm². The thickness T (μm) of the flaked aggregates 35 was set to 0.15 μm. In this case, the change rate (%) of the heat generating speed (° C./sec) of the positive electrode plate 3 was 92%.

In Example 5, the ratio R (wt %) of the flaked aggregates 35 to the entire conductive material was set to 1.00 wt %. The planar area A (μm²) of the flaked aggregates 35 was set to 9.2 μm². The thickness T (μm) of the flaked aggregates 35 was set to 0.11 μm. In this case, the change rate (%) of the heat generating speed (° C./sec) of the positive electrode plate 3 was 74%.

In Example 6, the ratio R (wt %) of the flaked aggregates 35 to the entire conductive material was set to 0.64 wt %. The planar area A (μm²) of the flaked aggregates 35 was set to 8.0 μm². The thickness T (μm) of the flaked aggregates 35 was set to 0.12 μm. In this case, the change rate (%) of the heat generating speed (° C./sec) of the positive electrode plate 3 was 78%.

In Example 7, the ratio R (wt %) of the flaked aggregates 35 to the entire conductive material was set to 1.47 wt %. The planar area A (μm²) of the flaked aggregates 35 was set to 5.2 μm². The thickness T (μm) of the flaked aggregates 35 was set to 0.11 μm. In this case, the change rate (%) of the heat generating speed (° C./sec) of the positive electrode plate 3 was 91%.

In Example 8, the ratio R (wt %) of the flaked aggregates 35 to the entire conductive material was set to 0.37 wt %. The planar area A (μm²) of the flaked aggregates 35 was set to 5.4 μm². The thickness T (μm) of the flaked aggregates 35 was set to 0.13 μm. In this case, the change rate (%) of the heat generating speed (° C./sec) of the positive electrode plate 3 was 76%.

### Summary of Experiment 2

FIG. 11 is a graph comparing the change rate (%) of the heat generating speed (° C./sec) corresponding to differences in the ratio R of the flaked aggregates 35 (to conductive material). As shown in FIG. 11, the change rate (%) of the heat generating speed (° C./sec) was 100% in Comparative Example 3. In contrast, the change rate of the heat generating speed (° C./sec) was 92% in Example 4, 74% in Example 5, 78% in Example 6, 91% in Example 7, and 76% in Example 8. This indicates that Examples 4 to 8 significantly reduced heat generation.

In this case, the total amount of the fibrous conductive material 34 (including flaked aggregate 35) was 0.8 wt % of the positive electrode mixture layer 32 in each example.

In Comparative Example 3, the planar area A (μm²) of the flaked aggregates 35 was 0 μm² since the flaked aggregates 35 were absent. The planar area A (μm²) of the flaked aggregates 35 was 6.3 μm² in Example 4, 9.2 μm² in Example 5, 8.0 μm² in Example 6, 5.2 μm² in Example 7, and 5.4 μm² in Example 8. Heat generation was reduced when the planar area A (μm²) of the flaked aggregates 35 was in a range of 5.2 to 9.2 μm².

In Comparative Example 3, the thickness T (μm) of the flaked aggregates 35 was 0 μm since the flaked aggregates 35 were absent. The thickness T (μm) of the flaked aggregates 35 was 0.15 μm in Example 4, 0.11 μm in Example 5, 0.12 μm in Example 6, 0.11 μm in Example 7, and 0.13 μm in Example 8. Heat generation was reduced when the thickness T (μm) of the flaked aggregates 35 was in a range of 0.11 to 0.15 μm.

When the ratio R of the flaked aggregates 35 was greater than or equal to 0.04 wt %, the change rate of the heat generating speed (° C./sec) was 92% in Example 4, 74% in Example 5, 78% in Example 6, 91% in Example 7, and 76% in Example 8. This indicates that Examples 4 to 8 significantly reduced heat generation.

Thus, Experiment 2 confirmed that in order to reduce heat generation effectively, it is desirable that the flaked aggregates 35 have the ratio R of 0.04% or greater, as shown in FIG. 11.

An appropriate upper limit of the ratio R of the flaked aggregates 35 was established based on a factor unrelated to Experiment 2. It is desirable that the flaked aggregates 35 be less than or equal to 1.50 wt % of the entire fibrous conductive material 34. This is because migration of lithium ions will not be hindered as long as the ratio R of the flaked aggregates 35 is 1.50 wt % or less. Further, the combination of the fibrous conductive material 34 and the flaked aggregates 35 will form effective paths between the particles of the positive electrode active material 33 and the flaked aggregates 35. This constructs a conductive network and maintains the conductivity.

### Conclusion of Experiment 2

Experiment 2 confirmed that in order to reduce heat generation effectively, it is desirable that the flaked aggregates 35 be in a range of 0.04 wt % to 1.50 wt % of the entire fibrous conductive material 34.

### Experiments 3: Change Rate (%) of (Maximum) Heat Generating Speed (° C./sec) Corresponding to Difference in Thickness T (μm) of Flaked Aggregate 35

### Conditions for Experiment 3

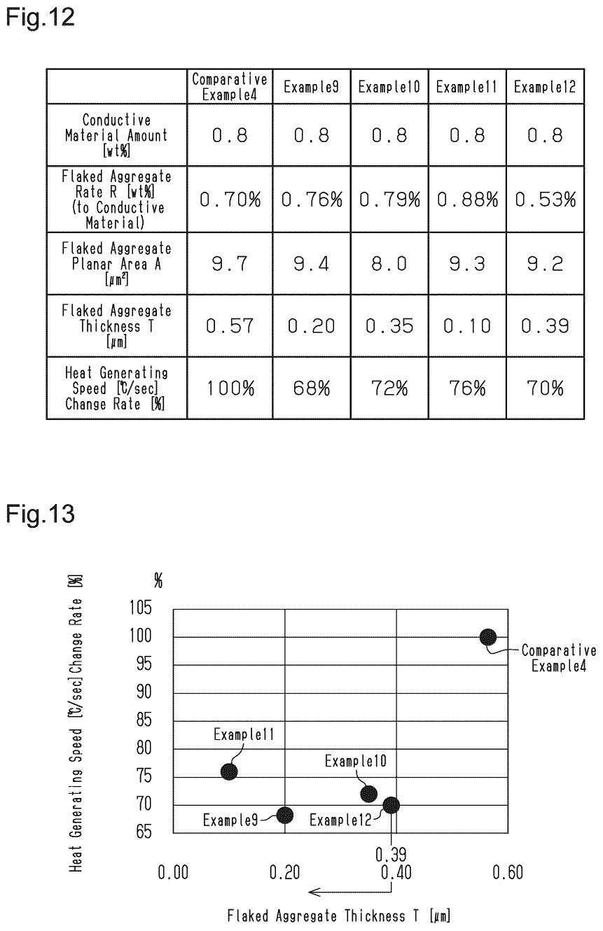

FIG. 12 is a table comparing the change rate (%) of the heat generating speed (° C./sec) corresponding to differences in the thickness T (μm) of the flaked aggregates 35. FIG. 13 is a graph comparing the change rate (%) of the heat generating speed (° C./sec) corresponding to differences in the thickness T (μm) of the flaked aggregates 35.

Examples 9 to 12 and Comparative Example 4 are compared below. In each example, the total amount of the fibrous conductive material 34 (including flaked aggregates 35) was 0.8 wt % of the positive electrode mixture layer 32.

In Comparative Example 4, the ratio R (wt %) of the flaked aggregates 35 to the entire conductive material was set to 0.70 wt %. The planar area A (μm²) of the flaked aggregates 35 was set to 9.7 μm². The thickness T (μm) of the flaked aggregates 35 was set to 0.57 μm. In this case, the change rate (%) of the heat generating speed (° C./sec) of the positive electrode plate 3 was defined as a reference of 100%.

In Example 9, the ratio R (wt %) of the flaked aggregates 35 to the entire conductive material was set to 0.76 wt %. The planar area A (μm²) of the flaked aggregates 35 was set to 9.4 μm². The thickness T (μm) of the flaked aggregates 35 was set to 0.20 μm. In this case, the change rate (%) of the heat generating speed (° C./sec) of the positive electrode plate 3 was 68%.

In Example 10, the ratio R (wt %) of the flaked aggregates 35 to the entire conductive material was set to 0.79 wt %. The planar area A (μm²) of the flaked aggregates 35 was set to 8.0 μm². The thickness T (μm) of the flaked aggregates 35 was set to 0.35 μm. In this case, the change rate (%) of the heat generating speed (° C./sec) of the positive electrode plate 3 was 72%.

In Example 11, the ratio R (wt %) of the flaked aggregates 35 to the entire conductive material was set to 0.88 wt %. The planar area A (μm²) of the flaked aggregates 35 was set to 9.3 μm². The thickness T (μm) of the flaked aggregates 35 was set to 0.10 μm. In this case, the change rate (%) of the heat generating speed (° C./sec) of the positive electrode plate 3 was 76%.

In Example 12, the ratio R (wt %) of the flaked aggregates 35 to the entire conductive material was set to 0.53 wt %. The planar area A (μm²) of the flaked aggregates 35 was set to 9.2 μm². The thickness T (μm) of the flaked aggregates 35 was set to 0.39 μm. In this case, the change rate (%) of the heat generating speed (° C./sec) of the positive electrode plate 3 was 70%.

### Summary of Experiment 3

In Comparative Example 4, the thickness T (μm) of the flaked aggregates 35 was 0.57 μm. The thickness T (μm) of the flaked aggregates 35 was 0.20 μm in Example 9, 0.35 μm in Example 10, 0.10 μm in Example 11, and 0.39 μm in Example 12. In Examples 9 to 12, the thickness T (μm) of the flaked aggregates 35 was in a range of 0.10 to 0.39 μm, in contrast with 0.57 μm of Comparative Example 4.

As shown in FIG. 13, the change rate (%) of the heat generating speed (° C./sec) of the positive electrode plate 3 was 100% in the Comparative Example 4. In contrast, the change rate (%) of the heat generating speed (° C./sec) of the positive electrode plate 3 was in a range of 68 to 76% in Examples 9 to 12. This indicates that Examples 9 to 12 significantly reduced heat generation.

In this case, the total amount of the fibrous conductive material 34 (including flaked aggregate 35) was 0.8 wt % of the positive electrode mixture layer 32 in each example.

The ratio R (wt %) of the flaked aggregates 35 to the entire conductive material was in a range of 0.53 to 0.88 wt % in Examples 9 to 12, in contrast with 0.70 wt % in the Comparative Example 4. The value of 0.70 wt % in Comparative Example 4 was approximately the median value of the range. In particular, although the rate R (wt %) of the flaked aggregates 35 was 0.53 wt %, which is a disadvantageous condition, in Example 12, the change rate of the heat generating speed (° C./sec) of the positive electrode plate 3 was 70%. This indicates that Examples 9 to 12, in which the change rate (%) of the heat generating speed (° C./sec) of the positive electrode plate 3 was in a range of 68 to 76%, significantly reduced heat generation.

Further, the planar area A (μm²) of the flaked aggregates 35 was 9.7 μm in Comparative Example 4. In contrast, the planar area A (μm²) of the flaked aggregates 35 was in a range of 8.0 to 9.4 μm in Examples 9 to 12, which were smaller than Comparative Example 4. In particular, the planar area A (μm²) of the flaked aggregates 35 in Example 10 was disadvantageous at 8.0 μm², compared to Comparative Example 4. Nonetheless, the change rate (%) of the heat generating speed (° C./sec) of the positive electrode plate 3 in Examples 9 to 12 was in a range of 68 to 76% of that in Comparative Example 4. This indicates that Examples 9 to 12 significantly reduced heat generation.

Therefore, Experiment 3 confirmed that in order to reduce heat generation effectively, it is desirable that the flaked aggregates 35 have the thickness T (μm) of 0.39% or less, as shown in FIG. 13.

### Conclusion of Experiment 3

It was confirmed through Experiment 3 that in order to reduce heat generation effectively, it is desirable that the thickness T (μm) of the flaked aggregates 35 be less than or equal to 0.39%.

### Operation of the Present Embodiment

The positive electrode plate 3 for a lithium-ion rechargeable battery in the present embodiment is configured so that the fibrous conductive material 34, which is carbon nanotubes, forms a conductive network that electrically connects the particles of the positive electrode active material 33 in the positive electrode mixture layer 32. Further, part of the fibrous conductive material 34 is aggregated to form the flaked aggregates 35. The flaked aggregates 35 are substantially disc-shaped and formed such that the planar area A, which corresponds to the bottom surface area of individual flake, is 2.84 μm² or greater and the thickness T (μm) is 0.4 μm or less. The flaked aggregates 35 have a porosity of 30% or less. The flaked aggregates 35 are in a range of 0.04 wt % to 1.47 wt % of the entire fibrous conductive material 34.

Such flaked aggregates 35 do not adhere to the granular positive electrode active material 33, and the non-aqueous electrolyte solution 13 is in contact with the substantially entire surfaces of the flaked aggregates 35.

When overcharging or the like increases the surface temperature of the particles of the positive electrode active material 33, thermal gradient occurs in the fibrous conductive material 34 tangled on the surfaces of the particles of the positive electrode active material 33. This conducts the heat to the fibrous conductive material 34 having a satisfactory thermal conductivity. Typically, the heat is directly dissipated from the fibrous conductive material 34 tangled on the surfaces of the particles of the positive electrode active material 33 to the non-aqueous electrolyte solution 13. In the present embodiment, the flaked aggregates 35 also dissipate the heat to the non-aqueous electrolyte solution 13. The flaked aggregates 35 have a relatively high thermal capacity due to the porosity being less than or equal to 30% and the volume being greater than individual fiber of the fibrous conductive material 34. Further, the flaked aggregates 35 are connected to the fibrous conductive material 34 adhered to the positive electrode active material 33 and form a conductive network. In other words, thermal conduction is performed between the flaked aggregates 35 and the fibrous conductive material 34 adhered to the positive electrode active material 33. Heat is readily conducted from the fibrous conductive material 34 to the flaked aggregates 35 in accordance with thermal gradient because of the extremely high thermal conductivity of the carbon nanotubes. Further, heat is readily dissipated from the flaked aggregates 35 to the non-aqueous electrolyte solution 13 without being stored in the flaked aggregates 35 since the thickness T (μm) of the flaked aggregates 35 is less than or equal to 0.4 μm. The flaked aggregates 35 act as heat dissipation fins of the positive electrode active material 33. When the heat of the positive electrode active material 33 is readily dissipated, increases in the temperature of the positive electrode active material 33 are limited. Therefore, even when overcharging or the like generates heat in the surfaces of the particles of the positive electrode active material 33, increases in the temperature at the surfaces will be limited and thermal decomposition of the non-aqueous electrolyte solution 13 will be reduced. This minimizes deterioration of the lithium-ion rechargeable battery.

### Advantages of the Present Embodiment

The present embodiment having the above described configuration has the following advantages.
(1) The positive electrode plate 3 for a lithium-ion rechargeable battery in the present embodiment performs sufficient heat dissipation even when a small amount of the fibrous conductive material 34 is used. This reduces decomposition of the non-aqueous electrolyte solution 13 caused by a high temperature at the surfaces of the particles of the positive electrode active material 33 during overcharging. As a result, deterioration of the lithium-ion rechargeable battery resulting from overcharging is minimized.
(2) The present embodiment includes the fibrous conductive material 34 dispersed on the positive electrode active material 33, and the flat flaked aggregates 35 of the fibrous conductive material 34 that do not adhere to the positive electrode active material 33. Thus, the fibrous conductive material 34 readily conducts heat generated in the surfaces of the particles of the positive electrode active material 33 to the flaked aggregates 35 for dissipation.
(3) The planar area A of each flaked aggregate 35 is set to 2.84 μm² or greater. Thus, sufficient heat dissipation is performed in a greater area than that of the fibrous conductive material without the aggregates.
(4) The thickness T (μm) of each flaked aggregate 35 is set to 0.39 μm or less. Thus, sufficient heat dissipation is performed without trapping heat inside the flaked aggregates 35.
(5) The porosity of the flaked aggregates 35 is set to 30% or less. Thus, the flaked aggregates 35 having a high thermal capacity perform sufficient heat dissipation.
(6) The flaked aggregates 35 are greater than or equal to 0.04 wt % of the entire fibrous conductive material 34. This obtains sufficient heat dissipation performance.
(7) The flaked aggregates 35 are less than or equal to 1.47 wt % of the entire fibrous conductive material 34. This will not hinder migration of lithium ions. Further, the fibrous conductive material 34 in the form of fibers is combined with the fibrous conductive material 34 in the form of the flaked aggregates 35. Thus, the fibrous conductive material 34 forms paths between the particles of the positive electrode active material 33 and the flaked aggregates 35 such that the heat of the positive electrode active material 33 is readily conducted to the flaked aggregates 35.
(8) The length of the fibrous conductive material 34 is set to 100 nm or greater. This facilitates formation of a conductive network constructed by the conductive paths between fibers of the fibrous conductive material 34 and obtains a sufficient conductivity.
(9) The length of the fibrous conductive material 34 is set to 1000 nm or less. This avoids formation of lump-like aggregates by intermolecular force of hydrogen bonding between the fibers of the fibrous conductive material and ensures a sufficient conductivity.
(10) The fibrous conductive material 34 of the present embodiment is carbon nanotubes. This obtains favorable physical properties. Such physical properties include, but are not limited to chemical properties, electrical properties, mechanical properties, thermal conductivity, structural properties, and the like.
(11) The positive electrode active material 33 of the present embodiment is granulated lithium nickel manganese cobalt oxide having a large surface area. Thus, the positive electrode active material 33 easily releases oxygen and generates decomposition heat such that the advantages of the present embodiment are readily demonstrated.
(12) The lithium-ion rechargeable battery 1 of the present embodiment includes the positive electrode plate 3 of the present embodiment. This provides a lithium-ion rechargeable battery having a high overcharge tolerance.

### MODIFIED EXAMPLES

In the present embodiment, the lithium-ion rechargeable battery 1 for driving a vehicle is described as an example. However, the lithium-ion rechargeable battery 1 does not have to be mounted on a vehicle and may be used as a stationary battery or other types of batteries.

The lithium-ion rechargeable battery 1 having the rolled-type flattened electrode body 12 is described as an example. However, the electrode body may be cylindrical or flat.

The lithium-ion rechargeable battery 1 of the present embodiment is described as an example of the present disclosure and is not intended to limit the material, shape, and the like of the lithium-ion rechargeable battery 1.

The numerical values, ranges, threshold values, and the like in the present embodiment are merely used as preferred examples, and may be optimized by one skilled in the art in accordance with the configuration of the lithium-ion rechargeable battery.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A positive electrode plate for a lithium-ion rechargeable battery, the positive electrode plate comprising:
a positive electrode mixture layer including a positive electrode active material and a fibrous conductive material dispersed on the positive electrode active material,
wherein the fibrous conductive material includes flat flaked aggregates of the fibrous conductive material that do not adhere to the positive electrode active material.

2. The positive electrode plate according to claim 1, wherein the flaked aggregates each have a planar area of 2.84 μm² or greater.

3. The positive electrode plate according to claim 1, wherein the flaked aggregates each have a thickness of 0.39 μm or less.

4. The positive electrode plate according to claim 1, wherein the flaked aggregates have a porosity of 30% or less.

5. The positive electrode plate according to claim 1, wherein the flaked aggregates is 0.04 wt % or greater of the entire fibrous conductive material.

6. The positive electrode plate according to claim 1, wherein the flaked aggregates are 1.47 wt % or less of the entire fibrous conductive material.

7. The positive electrode plate according to claim 1, wherein the fibrous conductive material has a length of 100 nm or greater.

8. The positive electrode plate according to claim 1, wherein the fibrous conductive material has a length of 1000 nm or less.

9. The positive electrode plate according to claim 1, wherein the fibrous conductive material is carbon nanotubes.

10. The positive electrode plate according to claim 1, wherein the positive electrode active material is lithium nickel manganese cobalt oxide.

11. A lithium-ion rechargeable battery, comprising:
the positive electrode plate according to claim 9.
